(19) United States
(12) Patent Application Publication
(10) Pub. No.: US 2004/0123777 A1
(43) Pub. Date: Jul. 1, 2004

(54) Protocol for sampling and testing compositions related to a method for making road base from oil and gas waste

(76) Inventor: David L. Polston, Garden Ridge, TX (US)

Correspondence Address: Danield D. Chapman, Esq., JACKSON WALKER L.L.P., Suite 2100, 112 E. Pecan Street, San Antonio, TX, 78205, US

(21) Appl. No.: 10/736,337

(22) Filed: Dec. 15, 2003

Related U.S. Application Data
(60) Provisional application No. 60/433,425, filed on Dec. 13, 2002.

(51) Int. Cl. C09D 4/00

(52) U.S. Cl. 106/281.1

(57) ABSTRACT

The present invention provides a novel method to produce grade road base material using recycled oilfield waste, called “oil and gas waste,” and aggregate waste and a novel road base material. Hydration and mixing of the waste materials along with a binder, will achieve an irreversible pozzolanic chemical reaction necessary for stabilization into a road base. An asphalt emulsifier may be included in the binder to manufacture asphalt stabilized road base. The entire method is a cold batch process.

This application is based on and claims priority and incorporates by reference U.S. patent application Ser. No. 60/433,425, filed Dec. 13, 2003, U.S. patent application Ser. No. 10/062,119 filed Jan. 31, 2002, and which claims priority from 60/299,225 filed Jun. 19, 2001.

### FIELD OF THE INVENTION

Applicants' invention relates to a method for making road base using primarily waste material from oil and gas waste solids and non-hazardous industrial waste or natural occurring porous or semi-porous material to create a asphalt stabilized road base that is environmentally safe and meets industry standards for quality materials. More particularly, it relates to isolating oil and gas waste from the environment, treating the isolated oil and gas waste and combining, isolated, treated oil and gas waste material with aggregate to provide the major components for the roadbed base material.

### BACKGROUND INFORMATION

Because of their importance in all aspects of both business and private life, the construction of roads has historically been of prime importance to a society. That importance remains today. However, it has also become more apparent in recent years that most resources are not infinite but rather, are depletable. Additionally, disposing of waste materials is becoming harder and harder due both to space limitations and liability resulting from waste materials entering the environment.

Thus, there is a need for developing methods and devices to recycle waste products into new, usable products. If the components of roadbeds can be obtained from the waste products of other products and processes, then both waste product production is decreased and new product consumption is decreased. Further, it is advantageous to recycle waste products due to the economic advantage of using recycling materials and thus compounding return on the original costs of the products.

While oil and gas waste material has been a component of roadbed material there has in the prior art not existed a method, or structures for practicing the method of combining oil and gas waste product into a road bed in a manner such that the oil and gas waste material is isolated, at each step of it's acquisition, transportation, delivery, storage, treatment and mixing at a remote production plant so as not to contaminate the environment. “On the ground mixing” of oil and gas waste material to make a road base may be environmentally harmful. Applicant's use of a man made impervious layer “MMIL” and other devices and methods, in order to isolate both the oil and gas waste material, and any harmful bi-products thereof, during a process of producing a roadbed, at a plant or site designed for such novel processes and devices will yield benefits in a clean environment and also benefits and recovery of harmless compositions in the treatment process which may be further treated in such a manner as to either become benign and/or be recycled.

Moreover, Applicant's providing of a managed, isolated site and treatment process may yield more efficiency then a “on the ground process.” Applicant's processes and devices for such processes used at a remote site would typically use less equipment then “on the ground mixing.” Further, Applicant's novel method of stacking and of mechanical separation of the proportion of liquids from a portion of solids of oil and gas yields benefit in both isolating harmful oil and gas waste material from the environment but allows the recycling of liquid portions of the oil and gas waste material apart from the oil and gas material as a whole. Applicant provides a cement slab operation, for example, the stacking oil and gas material to generate gravity induced separation. On the ground operation requires spreading to dry the material-by absorption with the ground material. Applicant's methods are believed to environmentally sound and yield treatment of liquid portions for, for example recycling.

### SUMMARY OF THE INVENTION

The primary focus of the invention is the acquisition, transportation, storage and treatment of oil and gas waste as isolated from the environment at an environmentally safe facility, for use with other materials to make a suitable road base material. Treatment of isolated oil and gas waste is done to remove at least a portion of a liquid component, typically primarily oil and water to yield a treated oil and gas waste portion which is then combined, still isolated, with an aggregate and a binder and stabilizer to produce a suitable road base material. The treatment of the isolated oil and gas waste, while yielding a liquid portion may also yield other recyclable or useable products such as clean drilling mud. Clean drilling mud is a product often desired by oil and gas well drillers. Thus, it is the desired result of the present invention of using oil and gas waste material treated in isolation, such that it is converted into a material that is useable and, excepting perhaps “waste water” which may be reinjected or reused, yields environmentally friendly, economically valuable components.

Turning to the separation of the liquid component from the oil and gas waste material it is anticipated by the present invention that there are a number of methods of liquid portion removal. Each such method will allow separation without contaminating the environment. One such method is a novel means of stacking of oil and gas waste in an impervious container, to yield gravity induced separation of some of the liquid portion from the solid portion. Another method is mechanical separation, such as by a centrifuge. A third method is mixing with a dry material, such, for example, as soil, overburden, or caliche limestone, on a man-made or natural impervious layer (“MMIL”).

Such methods of treatment in isolation not only help keep the environment clean, but may yield, with further treatment, valuable material.

The present invention provides a novel method to produce road base material using waste products from one or both of two industries: oil and gas well drilling and from construction and/or demolition and manufacturing projects. The present invention also provides for a novel road base composition. The oilfield waste is typically comprised of hazardous and/or non-hazardous oilfield solid or liquid waste such as water based drilling fluid, drill cuttings, and waste material from produced water collecting pits, produced formation sand, oil based drilling mud and associated drill cuttings, soil impacted by crude oil, dehydrated drilling mud, waste oil, spill sites and other like waste materials tank bottoms, pipeline sediment and spillsite waste. Oilfield waste may include waste or recycled motor oil, petroleum based hazardous or non-hazardous materials, such oilfield waste materials are collectively referred to as “oil and gas waste material.” They typically have a solid component and a liquid component, the liquid component including quantities of oil and water. The solid components may be, in part, particulate, or cuttings.

An aggregate component of the road based material may include a non-hazardous industrial waste as defined in more detail below or any natural occurring stone aggregate such as limestone, rip rap, caliche, sand, overburden, or any other naturally occurring porous material. There may or may not be preparation of the aggregate material prior to combining with the treated oil and gas material to form the primary component of the road based material of Applicant's present invention.

The construction and/or demolition or manufacturing waste component of the aggregate material is typically comprised of non-hazardous industrial waste such as waste concrete, waste cement, waste brick material, gravel, sand, and other like materials obtained as waste from industrial construction, demolition sites, and/or manufacturing sites. Such materials are collectively referred to as “non-hazardous industrial waste.”

One application of the method of the present invention provides for recycling the oil and gas waste material and the non-hazardous industrial waste to combine to produce road base. Another application of the present invention provides for recycling the oil and gas waste material and an aggregate including limestone, rip rap, caliche, sand or any naturally occurring porous or semi-porous material to combine to produce road base. Hydration and mixing of the isolated, treated oil and gas waste material and aggregate along with a binder such as cement, fly ash, lime, kiln dust or the like, will achieve an irreversible pozzolanic chemical reaction necessary for a road base. An asphalt emulsifier may be included in the binder to manufacture asphalt stabilized road base. The ingredients are typically mixed in a cold batch process.

Solid waste from the oil and gas waste material typically contains naturally occurring aluminas and silicas found in soils and clays. The added pozzolan will typically contain either silica or calcium ions necessary to create calcium-silica-hydrates and calcium-aluminate-hydrates. A pozzolan is defined as a finally divided siliceous or aluminous material which, in the presence of water and calcium hydroxide will form a cemented product. The cemented products are calcium-silicate-hydrates and calcium-aluminate-hydrates. These are essentially the same hydrates that form during the hydration of Portland Cement. Clay is a pozzolan as it is a source of silica and alumina for the pozzolanic reaction. The aggregate including natural stone aggregate or non-hazardous industrial waste adds structure strength and bulk to the final mix.

The process of creating a stabilized road base using an aggregate including non-hazardous industrial waste and oil and gas waste material may incorporate a water based chemical agent such as waste cement, varying amounts of aggregate and waste to produce a cold mix, stabilized road base product. An aggregate crusher may process the inert material (typically aggregate including the non-hazardous industrial waste or natural stone aggregate), into the size and texture required (from, for example ½″ to 4″). The aggregate is added to the treated oil and gas waste material at a desired ratio in a manner that prevents contamination of the environment. It has been found that an approximate ratio of one-to-one treated oil and gas waste material to aggregate provides a good mix. This could vary depending upon the degree of contamination or the quality of the oil and gas waste. A chemical reagent may be added to congeal the mixture. An asphalt emulsifier is added to create an asphalt stabilized road base. The resulting product is a stabilized road base that not only is of a superior grade, but is environmentally safe.

In order to further the environmental objectives of the present invention, it is desirable to isolate the oil and gas waste material from the source to the site and at the site from the environment prior to during and after mixing. Thus, while the aggregate may be stored on the ground, oil and gas waste material should be received, transferred and stored surrounded by a berm and/or placed on a cement pad, or otherwise isolated by a physical barrier that will prevent leaching of contaminates into the soil. This also prevents storm water runoff. The manufactured road base typically is mixed, processed, and likewise stored surrounded by an earthen berm and on a cement pad and/or other physical barrier that will prevent leaching of contaminates into the soil. Thus, the present invention provides a novel method that will produce an environmentally safe grade road base material.

Among the objectives of the present invention are to:

a. provide isolation of environmentally harmful oil and gas waste from acquisition through to treatment of and conversion to environmentally safe products;

b. combine treated oil and gas waste material with aggregate to produce a stabilized road bed composition;

c. reduce waste from oil and gas drilling, and construction/demolition and manufacturing;

d. reduce the use of new materials for roadbeds;

e. provide a method for producing roadbed material at a lower cost than conventional methods;

f. provide methods and devices for treating oil and gas waste material isolated from the environment, to yield a material that can be used for preparing a stabilized roadbed and also yield clean drilling mud and water;

g. combine treated oil and gas waste material with non-hazardous industrial waste or naturally occurring material to yield an environmentally safe, usable, stabilized road bed composition;

h. provide simple methods and devices of removing a liquid component from oil and gas waste material while the oil and gas waste and the resulting components remain isolated from the environment;

i. recycle aggregate waste from construction, demolition and manufacturing sites; and

j. provide for a single site or location to which oil and gas waste is transported, stored and at which it is treated and mixed, in isolation from the environment, to form a road base composition.

### BRIEF DESCRIPTION OF THE DRAWINGS

FIG. 1 is an overview of a process of storage and treatment by dry mixing the oil and gas waste material.

FIG. 1A is a generalized view of a process of applicants present invention.

FIG. 2 is a flow chart illustrating an overview of a process of combining treated oil and gas waste material and aggregate to produce, typically in a pug mill or mixing device, waste mix 14, which cures to form a novel road base.

FIGS. 2A-2D illustrates applicants novel method and device for isolating stacking oil and gas waste material.

FIG. 3 and 3A represent preferred alternate embodiments of a process of treating the oil and gas waste material in isolations to prepare it for combination with the aggregate waste material.

### DETAILED DESCRIPTION OF THE PREFERRED EMBODIMENT

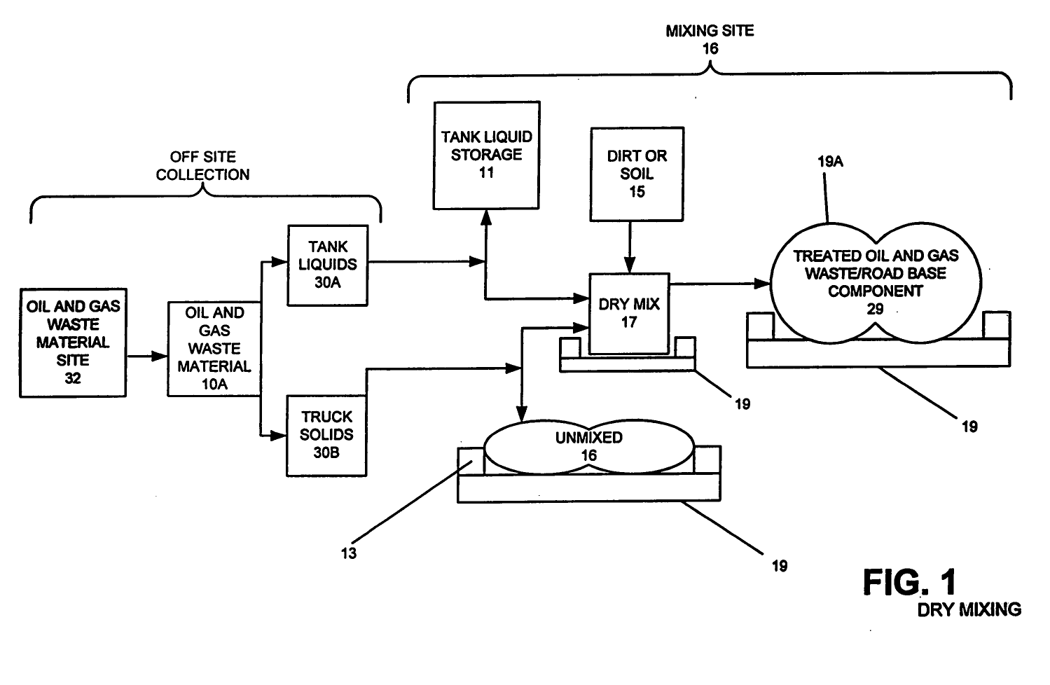

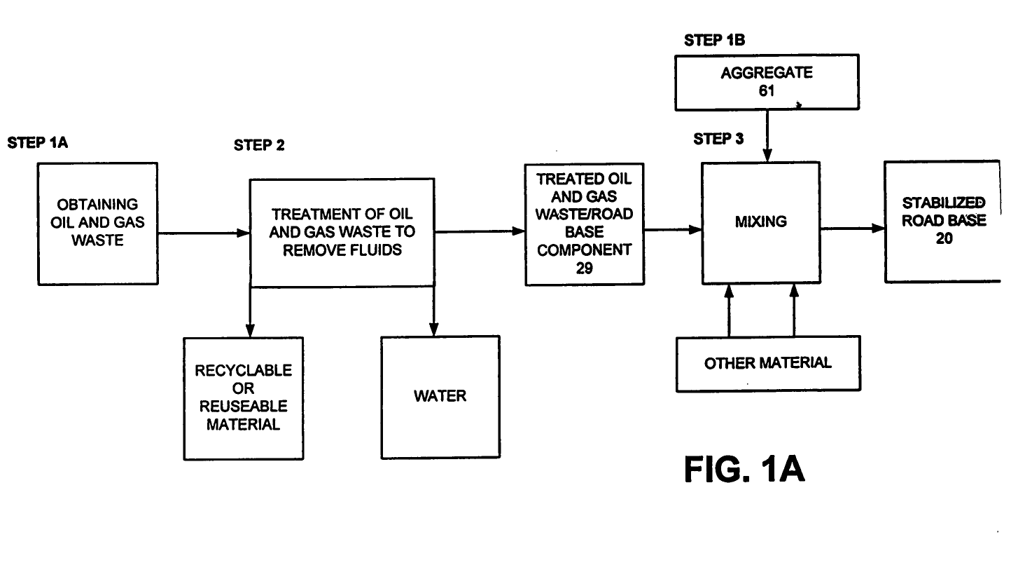

FIG. 1A illustrates an overview of the steps of Applicant's present invention. Applicant provides for, in obtaining step 1A, obtaining oil and gas waste from an oil and gas waste site as set forth in more detail below and transferring the waste to a treatment and mixing site. The second step, the obtaining step 1B, is that of obtaining an aggregate, typically inert, from a natural source such as limestone rock, caliche, rip rap, sand, dirt or the like or, as waste material from a construction, manufacturing, or demolition site. Step 2 is the treatment of oil and gas waste to remove fluids (or to remove solids) and obtain water and recyclable material, which water and material may be further processed. The third step is some form of mixing (as described in more detail below) wherein treated oil and gas waste is combined with aggregate and other material while in isolation from the environment to provide an environmentally safe roadbed.

Turning back to the oil and gas waste, it is typically transported to the treatment site where applicant's novel treatment provides several methods of removing at least some of the fluids, from the oil and gas waste material to provide a treated oil and gas waste material road base component which then is mixed with the aggregate to form a road base. As is apparent from FIG. 1A, the treatment step, step 2 removes water and solid and also provides for recyclable or reusable material, such as clean drilling mud and oil in step 2A. Further, it is seen that step 3, a step of mixing, may include not only the mixing of the aggregate with the treated oil and gas waste, but also mixing in other material such as binder, stabilizer, emulsion, etc., as set forth in more detail below. The result of the novel process is to provide a novel road base composition which is made up of treated oil and gas waste material and an aggregate and to apply such composition to a road base location.

Turning to FIG. 1, it is seen that, what is received from the oilfield site (32) at mixing site (16) is either tank liquids (30A) or truck solids (30B) sometimes called “cuttings”. We will call these materials collectively oil and gas waste material (10A). Upon arrival at mixing site (16), tank liquids (30A) may be deposited into a leak proof liquid storage tank (11). Truck solids (30B), which have a more solid like consistency than the tank liquids (30A), may be deposited on an impervious layer (19) and contained, typically, in an impervious earthen storage berm (13). FIG. 1 shows that tank liquids (30A) and truck solids (30B), collectively referred to as oil and gas waste material (10A) is obtained from an oilfield site (32) including but not limited to drilling sites, pit clean-up sites, spill clean-up sites, blow-out sites and oil and gas exploration, pipelines and refining industry or production sites. Typically the oil and gas waste material (10A) will be either “liquids” transported away from the oilfield site (32) in vacuum trucks or waste of a more “solid” or “slurry” consistency and transported in dump trucks. In both cases the transportation keeps the oil and gas waste separated from the environment and the trucks deposit their loads in means to isolate the material from the ground at the site. The oil and gas waste material (10A) is transported from the oilfield site (32) to a mixing site (16) by a first transport such as by a vacuum truck for liquids (“tank liquids”) (30A) or a second transport such as a dump truck for the “slurries” (“truck solids”) 30B.

FIG. 1 illustrates the dry mixing method of treatment; truck solids (30B) may be combined with soil (15) or other dry, absorptive indigenous material to help dry them and then stored on an impervious layer (19) as dried truck solids (17) in a storage pile (19A) on an impervious layer (19). The mixing and storage is typically done on an impervious layer. The impervious layers disclosed herein may be man-made, as from concrete, plastic, steel, the road base material described herein or the like. Indeed, all of the storage and treatment of the oil and gas waste material (10A) may take place in an enlarged enclosure the bottom of which has an impervious layer (19) and optionally, sides of which include a storage beam (13) made of either concrete or same other suitable material.

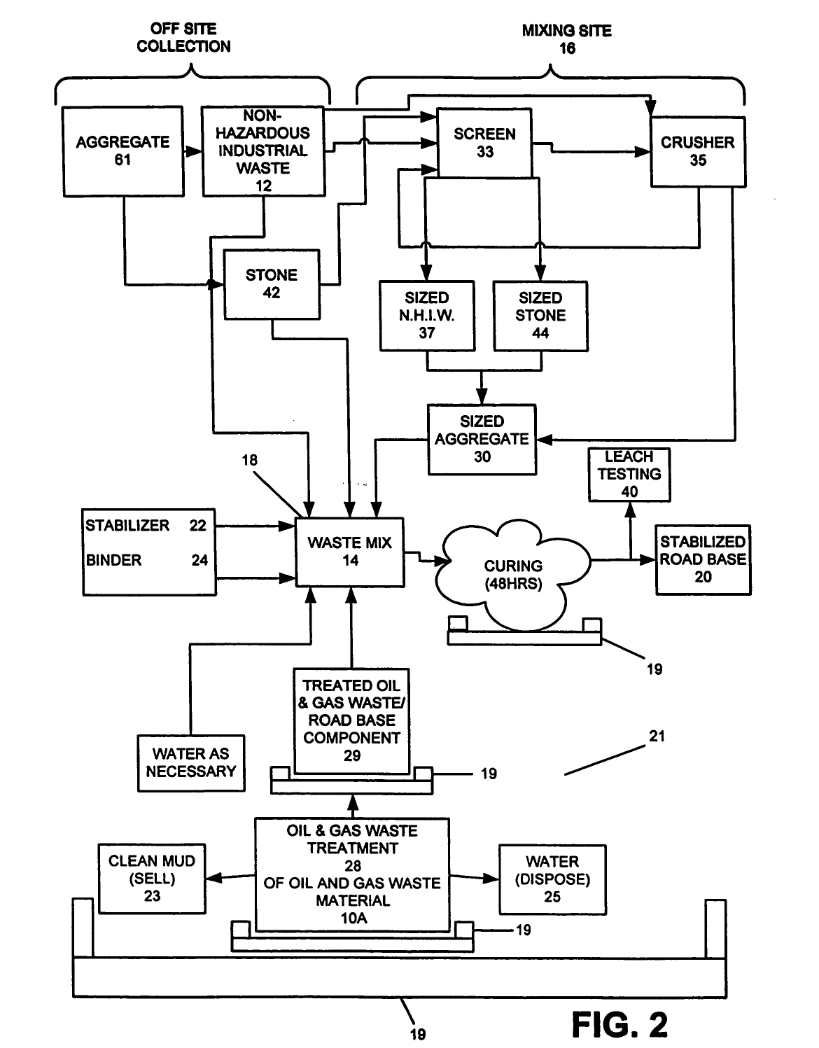

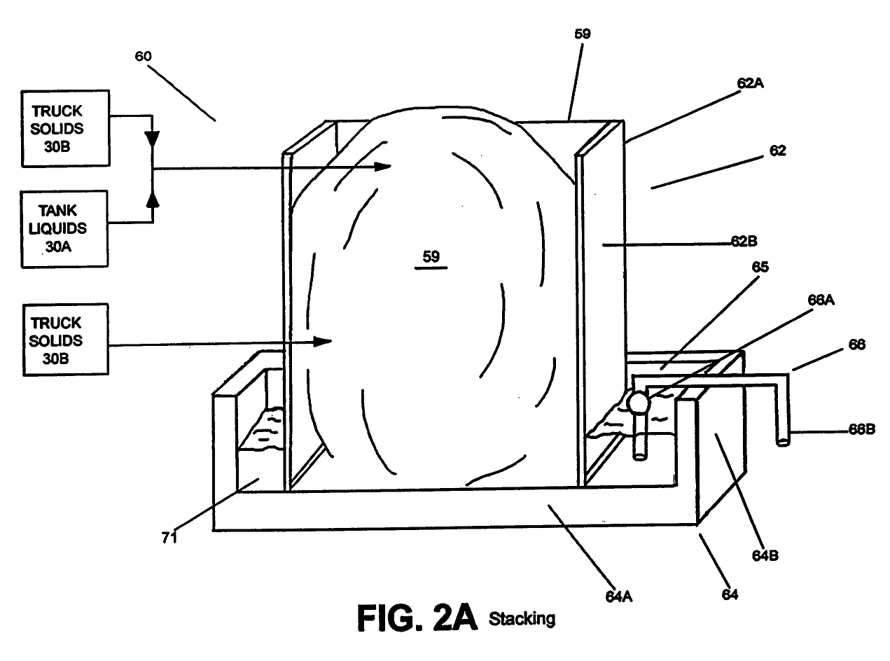

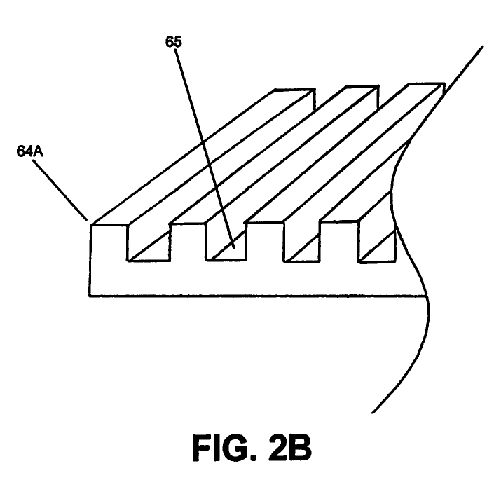

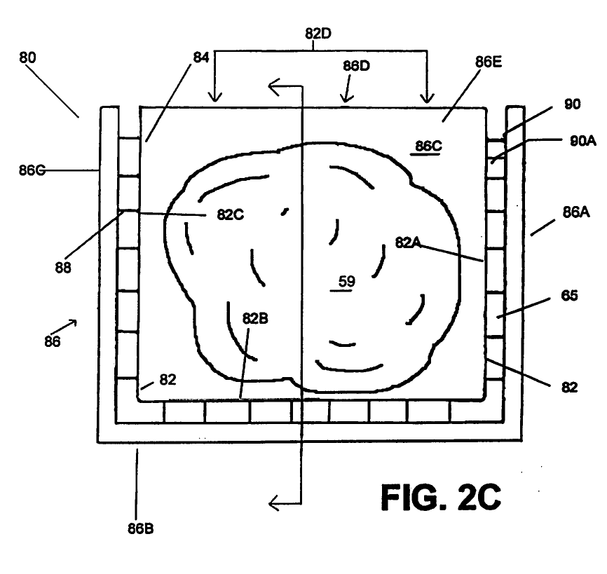

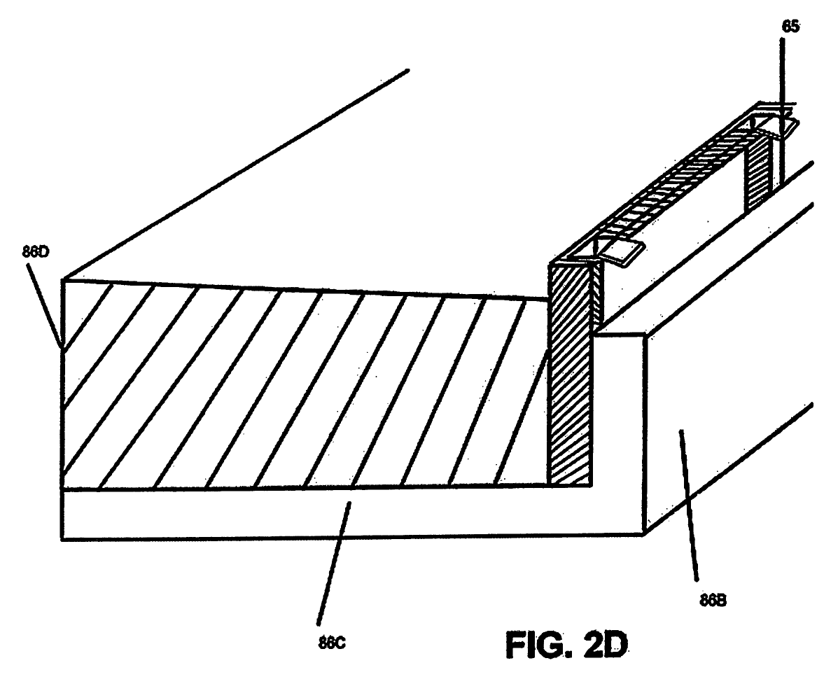

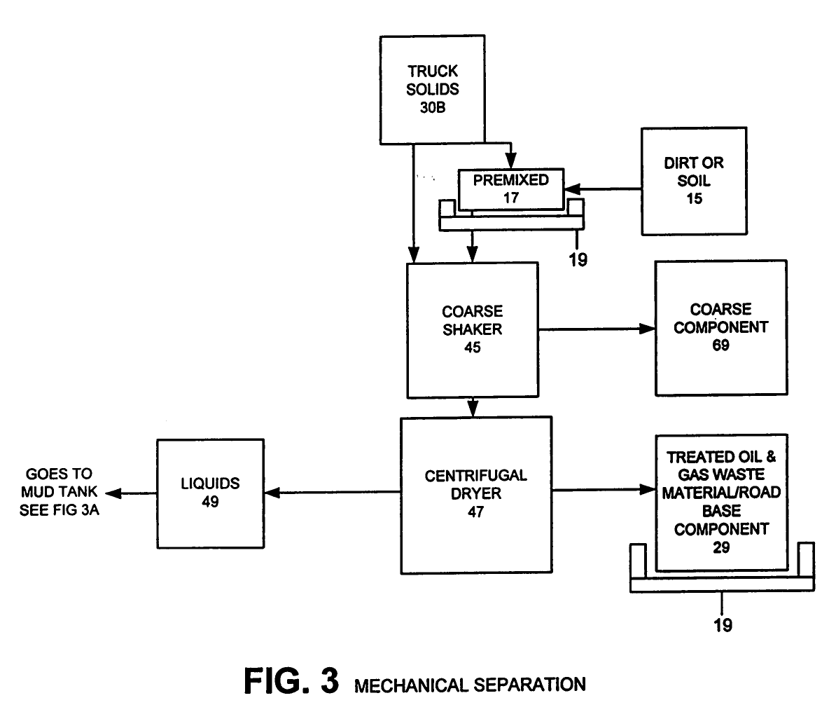

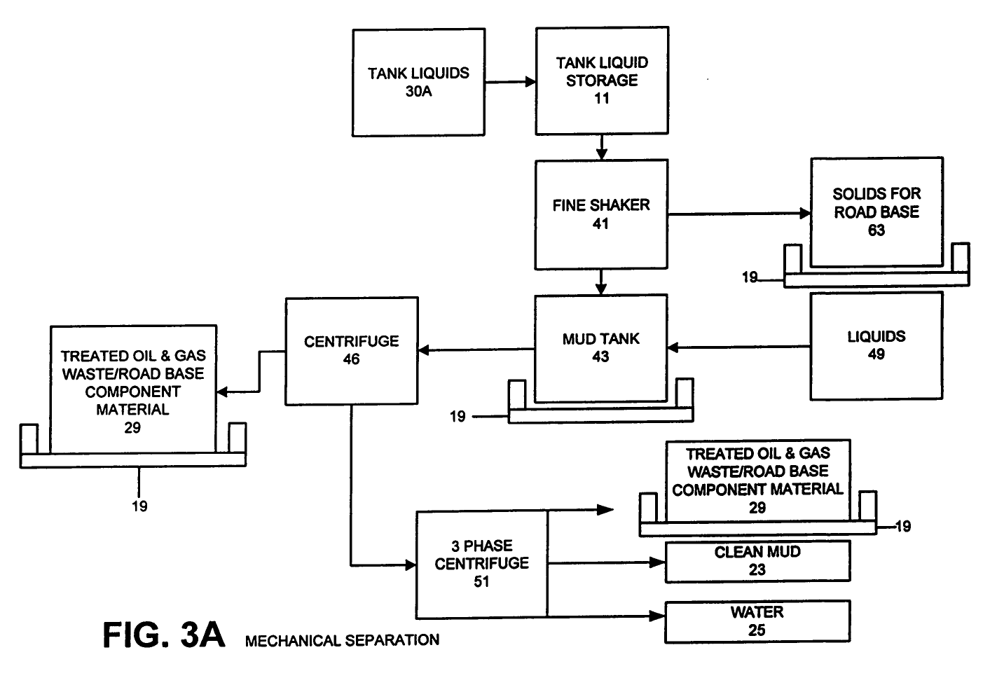

The next step in handling the oil and gas waste material (10A) is to treat it to at least remove some of the liquids therefrom (typically oil and water) so as to prepare a treated oil and gas waste/road base component material (29) for mixing in the pug mill (18) or mixing device to produce road base (20). Applicant provides a number of processes to treat the oil and gas waste material (10A). These processes include “dry mixing” as illustrated in FIG. 1, “stacking” as illustrated in FIG. 2B and “mechanical separation” as illustrated in FIGS. 3 and 3A. FIG. 1 illustrates a treatment of oil and gas waste material 10A.

Turning to FIGS. 2A-2D, Applicant's treatment by stacking is illustrated. In this preferred embodiment of treatment of oil and gas waste by way of a draining/evaporation process, the draining induced by gravity and the weight of the waste material itself is used along with a unique apparatus including a drainage assembly (60) to help remove oil and other liquids from either the truck solids (30B) or a mixture of truck solids (30B) and tank liquids (30A). It is pointed out here that it is preferable that the oil and gas waste material (10A) be treated to remove some of the liquids as it then makes the mixing of the road bed composition more effective. Typically, when the treated oil and gas waste material (10A) is paint filter dry or thereabout, it is sufficiently dry or damp to be processed in the pug mill or mixing device. Moreover, it is not necessary for all the fluids to be removed from the oil and gas waste material (10A) which may in fact, be somewhat damp after treatment.

Turning back to FIG. 2A it is seen that the stacking step (28A) includes a step of providing a drainage assembly (60) which includes a screened enclosure (62) typically three-sided and contained within the an impervious enclosure (64). More specifically, drainage assembly (60) is designed to contain within impervious enclosure (64) the screen enclosure (62) which is usually constructed from rigid frame member (62A) consisting of angle iron welded or bolted together, which frame members secure screened walls (62B), which screened walls may be made from a suitable screening material or expanded metal, with holes, typically in the range of sixty mesh to ¼ inch. The screened enclosure (62) is located in an impervious enclosure (64), which impervious enclosure includes a bottom wall (64A) and a side wall portion (64B). It is seen that the dimensions of the screen enclosure (62) are such that there is a gap created between screened wall (62B) and side wall (64B) of the impervious enclosure (64). It is in the gap (65) created by the dimensions of the screened enclosure (62) and impervious enclosure (64) respectively, that drainings (71), that is liquids comprising typically oil or some water, collect. Within screened enclosure (62) and typically piled such that its vertical height exceeds the length or width of the screened enclosure (62) is stacked oil and gas waste (59) which is comprised of either truck solids (30B) or a combination of truck solids (30B) and tank liquids (30A). Stacking the stacked oil and gas waste (59) in a manner so that is has a substantial vertical dimension (height) helps to ensure that there is sufficient weight to squeeze out drainings (71), which may be then evacuated either continuously or periodically from gap (65) through the use of a pumping or vacuum system (66). The pumping system includes pump (66A) and an engaging tube or hose (66B) or a vacuum hose attached to a vacuum truck (not shown). Tube or hose (66B) has a first end for immersion in the drainings (71) and a removed end outside impervious enclosure for transporting drainings to a desired site for isolation into the mud tank for further processing. Pump (66A) may be electric or hydraulic or any other suitable means and may be float controlled for it to be activated when draining (71) reaches sufficient depth within impervious enclosure (64).

An alternate preferred embodiment of Applicant's drainage assembly (60) there may be troughs or grooves (65) provided in the bottom wall (64A) of impervious enclosure (64) to assist in the draining of the stacked oil and gas waste (59) (See FIG. 2B).

The drainage assembly (60) may be any size, but is preferably designed to contain from 1 yard to 300,000 yards of stacked oil and gas waste (59) which may be dumped into the screened enclosure (62) using a front end loader or by dump truck or vacuum truck. They may be left to allow for the draining anywhere from a day to ten days or longer depending upon how saturated they are at the beginning of the treatment process. They are then removed from the screened enclosure (62) by any suitable method such as an excavator, to insure that they remain isolated from the ground and are then typically ready for transport to the crusher or the pug mill for mixing.

FIGS. 2C and 2D represent a top elevation and a cutaway side view of an alternate preferred embodiment of Applicant's drainage assembly (80). This embodiment differs from the embodiment illustrated in FIGS. 2A and 2B in several respects. First, the stacked oil and gas waste (59) is enclosed in a three-sided or walled mesh enclosure (82). That is, drainage assembly (80) includes a three-walled mesh enclosure (82) that consists of a side wall (82A), a back wall (82B) and a second side wall (82C), opposite side wall (82A). The three-walled mesh enclosure has an open front (82D). The mesh enclosure (82) lies within concrete retainer shell (86) or impervious layer and slightly spaced apart therefor to create a gap (65). Retainer shell (86), typically made from concrete and about three to twelve feet high, has typically three walls: side wall (86A), back wall (86B), second side wall (86C), the second side wall being opposite the first side wall. The retainer shell has an open front (86D) to allow dump trucks to back in and dump their load of oil and gas waste. A floor (86E), typically concrete, is provided.

The retainer shell is typically about 100 feet by 100 feet to 1,000 feet by 1,000 feet with the back and two side walls about three feet high. Further, the floor is typically slanted a few degrees from horizontal dipping towards the back wall to allow liquids to drain to the back rather than out the open front.

Mesh or screen sections (84) typically come in 4-foot by 8-foot sections and can be laid lengthwise inside the side and back walls of the impervious enclosure spaced apart therefrom by the use of steel braces (88) set vertically on the floor and typically having a length of about four feet (representing the height of the 4′×8′ sections) which lay on the concrete floor. The braces will prevent the mesh or screen (84) from collapsing from the weight of the oil and gas waste material stacked against them and the braces provide for a gap (65), usually about six inches or so, from which a pump or vacuum system and related plumbing may be provided to remove liquids accumulating therein. It is seen that across the top of the beams joining a top perimeter of the wire or mesh section may be a closed top (90) typically with an access door (90A). The function of the closed top is to prevent any oil and gas waste material stacked too high from falling over the top perimeter of the mesh section into the gap between the mesh section and the concrete wall. The access door may be opened to periodically insert a hose or pipe to evacuate accumulated liquids from gap (65). It is noted with reference to FIG. 2D that mesh typically stands a bit higher than the top of the three walls of the retainer shell. The space between the top of the impervious layer and the closed top (90) may be left open or closed with a suitable member. Closing that area would of coarse prevent accidental spillage of material into gap (65).

The material that accumulates in the gap is typically oil with some water and may be sent via pipe or truck, to the mud tank or used to add to clean mud. It further may be separated, having an oil component and a water component with the water component disposed of, and the oil component used to add to the clean drilling mud.

As is illustrated in FIG. 2, the oil and gas waste treatment (28) may also treat the oil and gas waste (10A) to remove a clean drilling mud component (23), and a water component (25), yielding treated oil and gas waste/road base component material (29). Such treated oil and gas waste/road base component material (29) may then be combined with stone (42), “sized” stone (44), non-hazardous industrial waste (12), or “sized” non-hazardous industrial waste (37) or a combination of the preceding. These may be combined directly with the treated oil and gas waste/road base component material (29) in a pug mill (18) or other suitable mixer or may be combined on an impervious pad to form a pre-mix (31), which is then deposited into a pug mill (18) or mixing device for further combining the two components together and for adding other components, such as portland cement (22) and a binder such as asphalt emulsion (24) to yield, upon curing, the stabilized road base (20) (water may be added as necessary).

The second of the two primary components of the stabilized road base (20) is an aggregate component (61) which is collectively either stone (42) (naturally occurring) and/or non-hazardous industrial waste (12). This non-hazardous industrial waste (12) typically consists of inert aggregate material, like broken up brick or cinderblock, broken stone, concrete, cement, building blocks, road way, and the non-metallic and non-organic waste from construction and demolitions site.

Non-hazardous waste (12) can be obtained from many sources and have many compositions. It includes waste brick materials from manufacturers, waste cement or other aggregate solid debris of other aggregate from construction sites, and used cement and, cement and brick from building or highway demolition sites.

Aggregate sites (34) include construction sites, building and highway demolition sites and brick and cement block manufacturing plants quarries, sand, dirt, or overburden or caliche pits. The aggregate is transported by dump trucks, conveyors or the like to mixing site (16) where it may be separated down to a smaller size, that is, into aggregate particles typically less than about 2½″ in diameter by running them through a screen (33). Any material that is left on top of the screen may go to a crusher (35). That material may go back to the screen (33) until, falling through the bottom of the screen and measuring less than about 2½″ in size. This will result in what is referred to as “sized” aggregate (30). This sized aggregate (30) is the aggregate component of the stabilized road base (20). It may then be combined with the treated oil and gas waste/road base component material (29) in a pre-mix as by using backhoes or loaders to scoop treated oil and gas waste/road base component material (29) to physically mix with sized aggregate (30) (or unsized aggregate) to create a pile or batch of pre-mix, which then can be added to the pug mill (18). Optionally, this premix, if it has sufficient dampness from residual oil and moisture, may be combined with sufficient portland cement (22) to coat the particles, before putting it into the pug mill (18). As set forth above, treated oil and gas waste/road base component material (29) may be deposited directly into the pug mill (18) and sized aggregate (30) can be separately dumped into the pug mill (18) and the material mixed directly without a pre-mix (31). Note that portland cement (22) and asphalt emulsion (24) may also be added to the pug mill (18) while the two primary components, treated oil and gas waste/road base component material (29) and aggregate are being mixed. Typically, the treated oil and gas waste/road base component material (29) and aggregate (30) are mixed in a ratio of about 50/50, but may be between 20/80 and 80/20. After the material is thoroughly mixed in the pug mill (18), it is deposited on an impervious layer and may be contained by an impervious berm (13) on a impervious layer (19) for curing (typically for about 48 hours). At this point, leachate testing (40) can also be performed to determine whether or not the ratios of any of the materials need to be adjusted. Leachate testing is done to ensure that contaminants in the road base meet leachate standards to the end users' specifications or any environmental agency.

The oil and gas waste material (10A) is comprised of hazardous and non-hazardous hydrocarbon based discarded material by oil and gas exploration production, transportation, and refining industries. Oil and gas waste material may include water base drilling fluid, drill cuttings, waste material from produced water collecting pits, produced formation sand, oil based drilling mud and associated drill cuttings, soil impacted by crude oil, dehydrated drilling mud, oil, pipelines and refining industries and like waste materials. It may be “dried” while isolated from the ground, by one or more of the novel drying processes disclosed herein. The term oil and gas waste material as used herein is not intended to be limited by definitions found in various codes or statutes.

Typically the oil and gas waste material (10A) contains enough liquids such that the aggregate (61) will likely become saturated if a mix is prepared without removal of some liquids. Therefore, the oil and gas waste treatment (28) of the tank liquids (30A) or truck solids (30B) is usually required. Oil and gas waste treatment (28) may also be used when clean drilling mud is desired, since clean drilling mud is often readily saleable. The oil and gas waste treatment (28) results in the production of clean oil and gas waste/road base component material (29) from the oil and gas waste material (10A).

The term “dry” is relative and means less liquid than before oil and gas waste treatment (28), typically, resulting in the loss of sufficient liquid such that mixing with the aggregate (61) will not result in saturation of the combination. If an oil and gas waste treatment (28) is used, then the treated oil and gas waste/road base component material (29) are mixed with the aggregate (61) and portland cement (22) and emulsion (24) in a ratio that results in an environmentally safe stabilized product. That ratio is determined by testing leachability of the road base for chemicals of concern as defined by the agency or end user; also for engineering strength by testing for example, compressive strength and vheem stability. The ratio may be between 20/80 and 80/20, typically about 50/50. Whether oil and gas waste material (10A) is mixed with aggregate (61) directly in a dry mix (17), or if oil and gas waste (10A) is subjected to oil and gas waste mechanical or stacking treatment and treated oil and gas waste/road base component material (29) are mixed with aggregate (61), an oil/aggregate mix (14) results from by the combination.

Typically, aggregate (61) is optimally sized to ¾ inch to 1-½ inch diameter pieces but may include a substantial portion smaller than ¾″. Therefore, a determination of desired size is made and, if the aggregate material is in pieces that are determined to be too large, they may be crushed in a crushing process (35) such as by a jaw crusher, to obtain the desired size prior to being added to the treated oil and gas waste/road base component material (29).

It has been found that a pug mill (18) provides adequate characteristics for proper mixing. The characteristics of a good mixer are consistency, coatability and durability. An emulsion (24) is added to the oil/aggregate waste mix (14) in the pug mill (18). The emulsion (24) serves to hold or bind the treated oil and gas waste/road base component material (29) to the aggregate waste (12) when the components are mixed and cured. The stabilizer (22) is, typically, comprised of portland cement. A binder (24) is also provided, typically asphalt emulsion. While the portland cement and asphalt emulsion can be added in desired quantities, it has been found that portland cement added in range of ½-10% of the final product weight and asphalt emulsion added in range of ½-10% of the final product weight provides good characteristics for the finished product. The oil/aggregate waste mix (14), binder (24), and stabilizer (22) are mixed and cured and the final product, stabilized road base (20) as determined by engineering quality testing and leachate testing results. Portland cement and asphalt emulsion (emulsion optional) are added to the waste mix (14) and mixed into the pug mill (18) or may be added separately to the pug mill (18). Optionally, treated oil and gas waste/road base component material (29) which is sometimes damp, may be coated with portland cement before it goes into the pug mill (18). The pug mill mixing (18) is a cold batch process.

More details of Applicant's oil and gas waste material treatment (28) are provided for in FIGS. 3 and 3A. It will first be noted that one of the purposes of treating oil and gas waste material (10A) may be to derive from it clean drilling mud (23) which can be sold to oil and gas operators. This is done by removing water taken out of the oil and gas waste materials to be reinjected or otherwise reused. Secondly, removing the solids from the drilling mud which are used in the oil and gas waste component of the road base. Finally, the majority of the oil and gas waste material (10A), upon treatment, will result in treated oil and gas waste/road base component material (29), that is, oil and gas waste material (10A) from which at least some liquids have been removed.

Turning now to FIGS. 3 and 3A, it is seen that tank liquids (30A) and tank solids (30B) may be treated differently to achieve the removal of a liquid component and for the purposes of obtaining clean drilling mud. Turning to FIG. 3A, it is seen that tank liquids (30A) are typically stored in tank liquid storage (11) from which they may be piped to and deposited on the top of a fine shaker (41) which will typically remove off the top thereof a damp solids component (63). However, a substantial portion of the tank liquids (30A) will work through the fine shaker (41) into a mud tank (43) typically located just below the fine shaker (41). From the mud tank, the fluid will enter a centrifuge (46) which will separate out another damp solids component (65) and send a fluid component to a 3 phase centrifuge (51). From the 3 phase centrifuge will come an additional damp solids component (67), drilling mud (23) and water (25).

Turning now to the truck solids (30B), they may be stored, isolated “unmixed” (16) or in a storage pile of dried truck solids (17) (see FIG. 1) on an impervious layer. Either way, truck solids (30B) may be deposited, typically using a backhoe (or front loader) and a hopper and a conveyor belt onto a coarse shaker (45) off the top of which come particles which will be a coarse component (69). The coarse component is further treated by crushing. Much of the truck solids (30B) will, however, fall through the coarse shaker (45) and these are transported or dropped into a centrifugal drier (47). The centrifugal drier (47) will yield a treated oil and gas waste/road base component material (29C) and a liquid portion (49) which will be transported to mud tank (43) (see FIG. 3A for processing).

The coarse component (69) comes off the top of the shaker and typically includes large chucks of stone or rock which may be transported to the crusher. Occasionally, rags, wood, cans and other extraneous material may be found in this coarse component. This extraneous material may be isolated, transported and disposed of offsite in permitted landfills. It is noted that the crusher operation is typically isolated from the ground if it contains a portion of the coarse component to prevent contamination of the environment.

Thus it is seen that both tank liquids (30A) and truck solids (30B) coming from oil and gas waste material sites (32) will undergo some physical separation of some solids from liquids, the liquid portion of which will typically end up in mud tank (43). Following separation of liquids both resulting components remain isolated. The liquids in mud tank (43) will undergo a process that yields a treated oil and gas waste material/road base component material (29) and also clean drilling mud (23) and water (25).

Novelty is achieved in taking oil and gas waste material including tank liquids and truck solids and making a road base that meets industry standards and is environmentally safe. However, treatment is done at a remote site while isolating the oil and gas waste before and during treatment From the solids a liquid is extracted by stacking, dry mixing or mechanical separation. From the tank liquids a solid portion and a clean mud portion and water is produced (see FIGS. 3 and 3A). Depending on weather, type of or source of waste material, extent of drying desired, economic consideration, environmental consideration may dictate which of the three separation types, or combination of the three types will be used.

The oil and gas waste material that is treated according to Applicant's present invention usually contains a solid phase and a liquid phase. It is Applicant's novel methods of treatment that help remove a part of the liquid phase from solid waste and solid phase from liquid waste. The following areas list of some of the oil and gas waste material that may be subject to Applicant's novel treatment and use and Applicant's novel road base:

Drilling fluids and cuttings from onshore operations

Basic sediment and water (BS&W) and tank bottoms;

Condensate;

Deposits removed from piping and equipment prior to transportation (i.e., pipe scale hydrocarbon solids, hydrates and other deposits);

Drilling fluids and cuttings from offshore operations disposed of onshore;

Liquid and sludge;

Liquid and solid wastes generated by crude oil and tank bottom reclaimers;

Weathered oil;

Pigging wastes from producer operated gathering lines;

Pit sledges and contaminated bottoms from storage or disposal of exempt wastes;

Produced sand;

Produced water constituents removed before disposal (injection or other disposal);

Slop oil (waste crude oil from primary field operations and production);

Crude oil contaminated soil;

Work over wastes (i.e., blowdown, swabbing and bailing wastes);

Waste in transportation pipeline related pits;

Cement slurry returns from the well and cement cuttings;

Produced water- contaminated soils.

Trucks solids or tank liquids or any other oil and gas waste material may be transported to Applicant's novel treatment site (21) via a boat or a barge, if the site is built next to water. If not, barges and boats that carry oil and gas waste material from offshore operations may be bring such material to a dock for offloading onto tanks or trucks for transportation to the treatment site (21). Boats typically transport oil and gas waste from an offshore drilling operations isolated and large containers. Barges typically carry the oil and gas waste material in bulk.

It is noted throughout the figures that at each point in the storage and treatment of the oil and gas waste material and the components derive from it, there is isolation, as by a man made or natural impervious layer (19). Transportaion to the treatment site is via liquid tight trucks, that won't spill oil and gas waste. Indeed, treatment also occurs in isolation from the environment-as for example by storing, mixing and/or curing on an imperious layer. Further, it is noted that Applicant's provide a novel treatment site (21) which itself may be surrounded by a berm (13) such an earthen berm or an impervious berm and may also include an impervious floor. The impervious floor may be natural material such as clay or packed dirt or compacted soil or may be a man made material, such a heavy plastic or concrete. The novel treatment site (21) is underlain by an impervious layer and bermed so that incoming oil and gas waste material, which often contains an environmentally unsafe compositions, will be treated and stored in isolation and will leave the treatment site in an nonhazardous and safe form-as environmentally safe roadbase, clean mud for use in further drilling operations and water, for injection offsite.

Applicant's [IER's permitted] process renders oil and gas waste into a non-waste, commercial roadbase product. The resulting roadbase is typically not subject to further environmental regulation. The roadbase is typically approved for use in the commercial market without the need for any type of conveyance notification or deed recordation. Applicant's waste treatment process and use of the material as roadbase removes a waste generators' cradle-to-grave liability that is normally associated with traditional waste management.

The [PC&V, as part of RRC Permit STF-010,] novel process and roadbed material is designed to satisfy most Federal and State government Environmental Risk Standards and Load Bearing/Shearing Engineering Standards for manufactured cold mix asphalt stabilized roadbase. [IER's] For example, Applicant's process and operations are consistent with engineering and environmental rules, regulations, guidelines and specifications of the Texas Department of Transportation, Texas Commission on Environmental Quality, and the Railroad Commission of Texas.

Testing Procedures & Protocols for Receiving Non-hazardous and Oil and Gas Waste Into Cold Mix Asphalt Stabilized Roadbase

[Outlined herein is the process by which the engineering and environmental specifications of RRC Permit STF-010 are verified.] Process control & verification (PC&V) is designed to confirm environmental standards and engineering specifications required by the RRC and the Texas Department of Transportation (TxDot) or other state or federal agency. Required environmental standards for leaching chemicals of concern specific to [IER's] Applicant's manufacturing process are set forth by the RRC in the facility's Permit which is incorporated herein by reference. Engineering Specifications used by IER to demonstrate commercial grade roadbase may be found within TxDot Specification 3157 and the Permit. The PC&V is designed to document and verify Applicant's process of cold mix asphalt stabilized roadbase, manufactured from non-hazardous waste material.

I. Waste Profile Testing

Determine concentrations of TPH (total petroleum hydrocarbons), chlorides, and pH of incoming waste. This determination assists in efficient mix designs through Bench Scale and laboratory testing. See RRC Permit STF-010 II F3a incorporated herein by reference.

Grab samples are taken from each truckload of waste received, combined into a 200 cu yd composite sample, and laboratory tested for Chemicals of Concern (COC).

Determine through standard analytical testing of the recycled material to ensure that the cold mix roadbase manufacturing process has been successful in stabilizing COC's.

After mixing, a sample of uncured roadbase is taken from the pugmill conveyor belt during discharge. One grab sample is taken every 50 tons and combined to make a sixteen part composite sample representing 800 tons of manufactured roadbase.

Roadbase samples are laboratory tested for leachable RCRA Metals and Benzene by EPA Method 1312. A 7 Day Leachate Test, in accordance with TCEQ Chapter 335.521, is used to create a leachate for laboratory testing of TPH (EPA Method 1664), Chlorides and pH.

Waste Sample ID#'s are assigned to 200 cu yd composite samples. Processed material (Roadbase) Lot ID#'s are assigned to 800 ton composite samples.

The Roadbase material is tested by an approved laboratory for compressive strength by test method TEX 126-E and Vheem Stability by TEX 208-F. The results of this analytical testing determines whether the treatment process has rendered the material to meet or exceed the minimum engineering specifications listed in TxDot Specification 3157 required by RRC Permit STF-010. Sampling protocol for the engineering tests are the same as for environmental tests.

Environmental & Engineering Sampling Protocol

In accordance with generally accepted practice within the solidification/encapsulation industry, samples for environmental testing are collected at the same time and in the same manner as those for engineering testing. It is important sampling protocol mirror the operational procedure that will be used in everyday practice. Environmental sampling is designed to accurately reflect real world use of and resulting impacts on the recycled material. Solidified/encapsulated materials require an adequate holding time for the cement and asphalt emulsion to properly ‘cure’. Sample test results will not represent the true conditions of the finished roadbase product if ‘curing’ time is not considered during sample testing.

Samples for testing of environmental and engineering parameters are routinely collected. The collection routine is based upon the weight of the produced material. Grab samples of manufactured recycled product are taken from the end of the pugmill discharge conveyor every 50 tons. Sixteen individual grab samples make up one composite representing one 800 ton Lot. Samplers wear Latex gloves during the sampling process. Grab samples of manufactured recycled product are collected in clean 5 gallon plastic buckets and stirred with a clean tool. Buckets and tools are washed clean between each grab sample with Alconox and triple rinsed with distilled water.

Applicant's sampling schedule is stringent. Applicant's testing procedure requires a 16 part composite sample representing 800 tons. Applicant's sampling procedure results in a 400% representative part increase over some states sampling requirements. The increased sampling frequency practiced by Applicant ensures the composite sample is truly representative of each 800 ton Lot.

If daily production does not equal 800 tons, that day's production will be included in the following days production or prior days production, which ever applies, until 800 tons have been produced and sampled.

All the material collected in the bucket is labeled and retained. After adequate curing time has elapsed, some of the composite sample is removed and molded into three sample monoliths or “pucks”. Each puck weighs at least 250 grams. The pucks and the remaining bucket material are labeled with a unique Lot Tracking Number, such as IER 00101, IER 00102, etc.

One of three pucks is retained and archived at the facility while the other two are submitted for laboratory analysis.

The monolith or puck represents ready-to-use asphalt stabilized roadbase material. The puck is a representative example of each Lot's engineering properties and level of environmental risk. Sample integrity is maintained so test results will represent real world applications.

The addition of cement and/or asphalt emulsion to the cold mix solidification/encapsulation process stimulates a chemical reaction that stops or suppresses leaching of chemical constituents from the stabilized roadbase material. The solidification/encapsulation process creates an exothermic (heat releasing) chemical reaction during curing. Curing is complete when the temperature of the stockpiled roadbase returns to ambient temperature. Artificially refrigerating representative samples will prematurely slow down or stop the chemical reaction. Prematurely refrigerated samples will not be true representatives of the finished roadbase product. Bench Scale Testing and tests for leaching chemicals are performed on manufactured product to confirm mix design success.

Pucks are submitted for laboratory analysis as soon as possible after compaction. Preservatives (ice or chemicals) are not added to the samples during laboratory shipping. A Chain of Custody accompanies each set of samples.

Analytical testing conducted at the laboratory consists of the Synthetic Precipitate Leaching Procedure (SPLP) by EPA Method 1312 or the 1:4 Solid:Solution, Seven Day Distilled Water Leachate Test (TCEQ Chapter 335.521 (d) Appendix 4) depending on the chemicals of concern being tested. Representative samples are tested in accordance with Test Methods for Evaluating Solid Wastes Physical/Chemical Methods (SW-846).

Mechanical compaction of the processed material is performed in accordance with specifications found in TxDOT Method Tex-113- E or Structural Integrity Procedure (SIP) under the U.S. EPA Extraction Procedure Toxicity Method (13 10A). The modified TxDOT method is preferred by Applicant since the EPA Toxicity protocol fails to simulate a compaction effort similar to real world conditions. Compression testing and Vheem stability testing is performed in accordance with recommended methods.

A Daily Production Report is maintained to document the amount of waste processed, quantities of emulsion, aggregate and cement used in the processing of the roadbase, and an inventory of the amount of material undergoing curing on the curing pads. The Daily Production Report is also used to identify curing pad placement of any poor quality roadbase in the event the need for reprocessing should occur . This report lists all samples collected by individual grab sample number (1-16, etc.), collection method (i.e. composite), type of sample (environmental or engineering), samplers name or initials, the compaction date and time, shipping date and receiving laboratory. A copy of the Daily Production Report is maintained at Applicant's field office.

Waste operations supplying materials to Applicant for recycling receive a Certificate of Recycle when their material has been made into Asphalt Stabilized Roadbase. Laboratory test data is available to any roadbase end user upon request. Manufactured roadbase material made from recycled materials will not be released from the recycling facility without meeting permitted environmental levels and approved engineering specifications. See RRC Permit STF-010 II F 3b. Processed material not meeting environmental and engineering requirements will be reprocessed as required.

All processing equipment used during any Bench Scale Test is the same type of equipment used for the actual recycling of the waste. The equipment has the capability to mechanically control the feed rates for mixing and controlling additives. Application rate determinations, calibration of the equipment, and inspections of the plant are performed in accordance with the procedures established by Permit.

Roadbase material is stockpiled on a cement lined curing pad after recycling and processing operations are complete. Material may not be removed from the stockpile until PC&V process is completed. Stockpiling is done in a manner to ensure the homogeneous condition of the roadbase material and Permit compliance.

Applicant tracks each load of received waste by a Waste Sample Tracking Number from its point of origin to the curing pad. Processed material is tracked by Roadbase Lot Tracking Number, Roadbase Bill of Lading, and Certificate of Recycle.

Waste Sample Tracking Numbers are assigned in an ongoing numerical sequence in 200 cubic yard intervals. Manufactured roadbase Lot Tracking Numbers are assigned in numberical sequence every 800 tons.

Waste is received, sampled, treated, laboratory tested and tracked by an assigned ID number. Tracking ID numbers identify and account for the waste throughout the Recycle Process.

A Roadbase Bill of Lading follows each load of materials to its final destination. The Bill of Lading provides notice to the end user that Applicant's manufactured roadbase material has been successfully processed in accordance with the environmental agency permit.

A Certificate of Recycle is issued to the waste provider upon completion of the recycling process. The recycling process is complete when the non-hazardous waste has been successfully processed into asphalt-stabilized roadbase. Documentation showing waste generator, waste profile, waste volume, and laboratory test results are kept on file at the Applicant's facility office.

Upon successful completion of the PC&V process, the material may be used as roadbase in accordance with the agency permit. The roadbase material is no longer classified as an oil and gas waste, but rather a manufactured commercial product not subject to regulation as a waste.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method of preparing a composition for use as a road base comprising the steps of:
obtaining and isolating a quantity of oil and gas waste material from a first site;
obtaining a quantity of aggregate from a second site;
transporting as isolated said quantity of oil and gas waste material from said first site to a third site;
transporting said quantity of aggregate from said second site to said third site;
receiving and storing, in isolation at the third site, the oil and gas waste material;
forming an oil/aggregate mix by combining a portion of said quantity of oil and gas waste material with a portion of said quantity of aggregate said forming accomplished without contamination of the ground of the third site;
adding a binder to said oil/aggregate mix;
mixing said binder and stabilizer with said oil/aggregate mix to create a quantity of said road base; and,
sampling both before the storing step and after the mixing step testing the material for compliance with a preselected physical and chemical profile.

2. The method of claim 1 wherein said mixing and curing step is selected to bind preselected chemicals from said oil and gas waste so that said chemicals create substantially no leachate from said quantity of roadbase material.

3. The method of claim 1 further including identifying by number a stored quality of oil and gas waste material by source, tracking said quality through, at least testing step and archiving such results.

4. The method of claim 1 wherein said transportation of oil and gas waste is done by boat.

5. The method of claim 1 wherein said transportation of oil and gas waste is done by truck.

6. The method of claim 1 wherein the receiving, storing, forming, adding, mixing, sampling and storing steps are performed at a site underlain by an impervious layer.

7. The method of claim 6 wherein the impervious layer is man-made.

8. The method of claim 6 wherein the impervious layer is natural.

9. The method of claim 1 wherein the receiving, storing, forming, adding, mixing, sampling and storing steps are performed within an area defined by an impervious berm.

10. The method of claim 9 wherein the receiving, storing, forming, adding, mixing, sampling and storing steps are performed within an area defined by an impervious berm is concrete.
